(19) United States
(12) Patent Application Publication
(10) Pub. No.: US 2017/0287140 A1
(43) Pub. Date: Oct. 5, 2017

(54) High quality Lightning resilient segmentation system using active background

(71) Applicants: Sylvain Cardin, Essertines sur Yverdon (CH); Julien Vincent, Renens (CH); Frederic Condolo, Montreux (CH)

(72) Inventors: Sylvain Cardin, Essertines sur Yverdon (CH); Julien Vincent, Renens (CH); Frederic Condolo, Montreux (CH)

(21) Appl. No.: 14/616,831

(22) Filed: Feb. 9, 2015

(51) Int. Cl. G06T 7/194; H04N 9/75; H04N 5/262; H04N 5/222

(52) U.S. Cl. CPC G06T 7/194; H04N 5/2226; H04N 9/75; H04N 5/262

(57) ABSTRACT

The present invention refers to the field of video processing, and, in particular, to a system and a method for achieving high quality foreground segmentation using an active background.

The present invention is embodied in a system and a method capable of achieving high quality foreground segmentation using an active background, wherein foreground is any object or person located between a camera and a background. The system is comprising an active background, one or several multispectral cameras, a hardware synchronizer, an invisible light driver and a main computer.

The main features of the system consist of one or several of the following:
a. A sub-system acquiring reference images of the active background.
b. A sub-system acquiring each video frame images.
c. A sub-system performing real-time frame processing
d. A sub-system performing noise reduction.

### FIELD OF THE INVENTION

The present invention refers to the field of video processing, and, in particular, to a system and a method for achieving high quality foreground segmentation using an active background.

### BACKGROUND OF THE INVENTION

Chroma key compositing, or chroma keying, is a special effects/post-production technique for compositing (layering) two images or video streams together based on color hues (chroma range). The technique has been used heavily in many fields to remove a background from the subject of a photo or video—particularly the news casting, motion picture and video game industries.

This technique still has some limitations. Obviously the foreground objects and persons can't feature a color similar to the background. The main issue is to achieve even lightning: The whole background has to appear to the camera as a uniform unique given color and have to be spotless of shade from the foreground onto the color background. Bright materials can also provoke segmentation errors by having the color spill onto them. Even a difference in the focal length of the lenses used can affect the success of chroma key.

The proposed invention describes not only how to achieve high quality and smooth foreground segmentation but also how to achieve proper lightning compensation and resilience. The system is able to operate in a wide range of lightning conditions and can potentially be used outdoors with indirect sunlight. By using the invention it could lead to breakthrough capabilities and cost reduction for applications in the fields covered by but not limited to:
Advertising and event campaigns
New generation of photomatons
Tourist and amusement park attractions (including theme parks)
Television broadcasting
Television mobile live studios
Cinema and movie production
Special effects productions

### SUMMARY OF THE INVENTION

The present invention is embodied in a system and a method capable of achieving high quality foreground segmentation using an active background, wherein foreground is any object or person located between a camera and a background. The system is comprising an active background, one or several multispectral cameras, a hardware synchronizer, an invisible light driver and a main computer.

The system is using the active background for illuminating in the invisible light spectrums and the multispectral cameras for simultaneously recording images in both visible and invisible spectrums. Comparing the invisible light images to a reference invisible light image set allows to identify the pixels that are occupied by the foreground, and thus to generate a foreground mask. According to an embodiment of the invention the main computer can further compute gradients from foreground to background pixels, used to interpolate color and alpha values. According to some embodiments of the present invention the active background is electronically controlled and it can trigger invisible light flashes only when required by the system. This way, the system can reduce artifacts by comparing natural ambient invisible light amount to invisible light emitted by the active background. The system finally generates a live stream of images containing an alpha channel insuring great looking spatial transition with the foreground.

The invisible light (further referred to as IL) is light that is not visible for the human eye but that can be filmed by dedicated cameras. This includes any spectrum that is below or above what the human eye can perceive (such as, but not limited to, infra-red or ultra violet spectrums). The visible light will be further referred to as VL. Ambient invisible light is IL that does not come from the active background. This can be natural infra-red light from the sun for example, or non-visible light coming out of halogen light bulbs. This non-controlled light generates noise for the system and will be further referred as ambient IL.

The active background is one or several surfaces emitting or reflecting IL towards one or several cameras. According to one of the embodiments of the invention the background is comprising an IL emitter (sources of invisible light such as projectors or LED strips) and a background surface that can either reflect or be transparent to IL. In such a configuration at least two setups can be used for the background. For example the IL emitter faces the background surface and in that case, the IL is emitted towards the surface and rebounds on the opaque and reflective background surface. Another example could be a setup wherein the IL emitter is behind the background surface and faces the camera. In this case, the IL travels through the background surface towards the camera. This time, the background surface is not opaque and reflective, but translucent to IL. The background surface may be painted or printed provided it respects the needs explained above (IL reflectivity or translucency). Translucency may be achieved using micro-perforated printed material.

According to some embodiments of the present invention electronically controlled IL emitting devices are used, that can be electronically switched on and off at a very high pace by the Hardware Synchronizer. Background is also called “active background” because it emits IL on demand.

The multispectral camera is able to record, for each pixel, a red, green and blue value (RGB color model) from the visible spectrum and also a value for a specific narrow band in the IL spectrums corresponding to the active background. In order to improve and widen the resilience to external lightning change, the camera is able to apply different settings for the gain to the visible light sensors and the IL sensors. External synchronization signals for each of the channels (RGB and IL) are available through general purpose input/output pins. Prism based multi CCD cameras often feature independent sensors for IL and visible spectrums.

The Hardware Synchronizer is kind of a metronome that synchronizes IL flashes with camera's images capture by means of at least three signals that can be generated:
one for the IL drivers of the active background so that it switches on or off the IL
one for the camera so that it snapshots a picture in the visible spectrum (RGB)
one for the camera so that it snapshots a picture in the invisible spectrums (IL)

It can be a simple microcontroller board running a program logic to generate the proper synchronization signals, logic that will be described in detail later in the document. Each of the signals can contain additional information, as for example timing and aperture time information for the camera signals.

According to some embodiments of the present invention the hardware synchronizer can work in different modes such as Flash, Strobe or Double Strobe depending on the available functionalities of the camera and a balance between latency and resilience. However when ambient IL is very low (generally indoors with controlled lighting system), the Hardware Synchronizer can be removed and leave the IL emitter always switched on. This allows the usage of a camera that wouldn't feature a synchronization signal.

The IL Driver is to power up and control the IL emitter according to the system requirements. As an example, if the lighting system is based on LED technology then its main interest is to provide the highest supported electric current to the lightning system with less than 10 us ramp up and down.

The main computer runs the video signal processing and performs the segmentation procedure. It has to be able to read the stream of incoming image data and have enough computational power both in term of CPU and GPU to achieve real time processing.

A general scheme of the components is presented in FIG. 1.

The main features of the system consist of one or several of the following:
a. A sub-system acquiring reference images of the active background.
b. A sub-system acquiring each video frame images (for both VL and IL).
c. A sub-system performing real-time frame processing
d. A sub-system performing noise reduction, available when Hardware Synchronizer is used either in Strobe or Double Strobe modes.

The first sub-system (a) comprises:
Acquiring reference images for the active background, both with and without illumination in the VL and IL spectrums. Performed on start-up, when there is no foreground object.
Creating 3 reference maps, storing for each pixel mean value and standard deviation:
   The first for the 3 color channels of the visible spectrum (RGB),
   The second with the IL spectrum values with backlighting on,
   And the third in the IL spectrum with backlighting off.
In one embodiment of the invention a re-calibration can be executed during the video recording. The reference images are automatically recomputed when no foreground object is detected for a given period of time.

The second sub-system (b) comprises:
Acquiring frame images for both VL and IL spectrums, wherein the IL exposure time is kept very short compared to the visible light exposure time.
Ensuring the active background lightning during the IL images acquisition either by keeping the IL emitter always switched on or by using the hardware synchronizer to set the timing for the invisible lightning system and the camera exposure.
Considering the usage of the hardware synchronizer different scenarios will be further described:
   When not used, the IL emitter is always switched on and the IL image is taken in the middle of the exposure time of the visible image
   When used in Flash mode, the active background will provide a short burst of IL, matching the short exposure window on the IL camera's sensor. The IL image is taken in the middle of the exposure time of the visible image.
   When used in Strobe mode, the IL lightning is alternatively switched on and off. For example, considering two consecutive frames, if for the first frame the IL image will be acquired with the active background on then for the second frame the IL image will be acquired having the active background off.
   When used in Double Strobe mode, the camera acquires two IL images for each RGB frame, one with the background IL on and the other with IL lightning off. The two IL images are taken as close as possible in time (in order to achieve best motion artefact reduction) while close to the middle of the exposure time of the visible image.

The third sub-system (c) comprises:
Generating a foreground/background segmentation by comparing current frame IL pixel values with the reference values from the second recorded map (IL spectrum values with backlighting on).
Generating a trimap, wherein any pixel within a given distance from the foreground/background boundary is marked as “unknown”.
Computing the alpha-channel, wherein the system estimates the ratio of foreground visibility for all “unknown” pixels of the trimap.
Removing the influence of the background from “unknown” pixels by the means of using the visibility ratio “alpha”.

The last sub-system (d) comprises:
Comparing two consecutive IL images (one with the background IL on and the other with the background IL off).
Subtracting the two consecutive IL images together and storing the absolute value for each pixel. This is to remove the ambient IL influence.
Storing the computed IL value for each pixel to be further used in the real time processing.
Considering the usage of the hardware synchronizer different scenarios will be further described:
   When in Strobe mode, the noise reduction will be performed for each VL frame, comparing the IL image from the current and the previous frame.
   When in Double Strobe mode, the noise reduction will be performed for each VL frame, comparing the two IL images acquired during the current frame.

Other features are inherent in the methods and systems disclosed or will become apparent to those skilled in the art from the following detailed description of embodiments and accompanying drawings.

### DESCRIPTION OF THE DRAWINGS

FIG. 1 schematically illustrates the system components of one embodiment of the invention

FIG. 2 schematically illustrates the process of performing a recording as a step by step diagram according to one of the embodiments of the invention

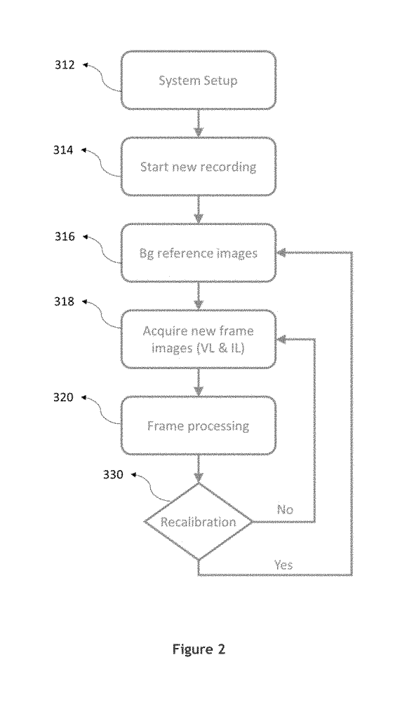

FIG. 3 schematically illustrates the real time video frames processing as a step by step diagram according to one of the embodiments of the invention

FIG. 4 schematically illustrates an example of the Trimap generation process according to one of the embodiments of the invention

FIG. 5 schematically illustrates the frame by frame images acquisition process (for both Visible Light and Invisible Light spectrums) according to one of the embodiments of the invention, in a setup where HW Synchronizer is not used.

FIG. 6 schematically illustrates the frame by frame images acquisition process (for both Visible Light and Invisible Light spectrums) according to one of the embodiments of the invention, in a setup where HW Synchronizer is used in Flash mode.

FIG. 7 schematically illustrates the frame by frame images acquisition process (for both Visible Light and Invisible Light spectrums) according to one of the embodiments of the invention, in a setup where HW Synchronizer is used in Strobe mode.

FIG. 8 schematically illustrates the frame by frame images acquisition process (for both Visible Light and Invisible Light spectrums) according to one of the embodiments of the invention, in a setup where HW Synchronizer is used in Double Strobe mode.

FIG. 9 schematically illustrates a generic computer description.

### DETAILED DESCRIPTION

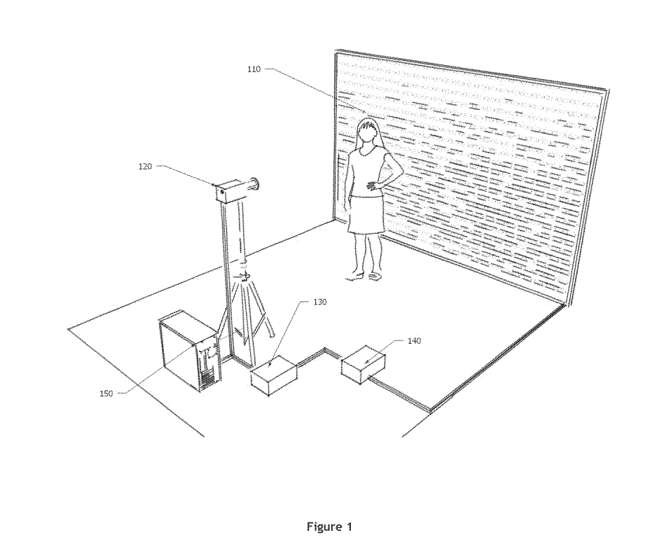

In a preferred embodiment, the system is composed of an active background (110), one or several multispectral cameras (120), a hardware synchronizer (130), an invisible light driver (140) and a main computer (150). A general scheme of the components is presented in FIG. 1. The active background (110) is illuminating in the invisible light spectrums (such as, but not limited to, infra-red or ultra violet spectrums) and the multispectral cameras (120) are simultaneously recording images in both visible and invisible spectrums. The main computer (150) is performing the real time processing by comparing the invisible light images to a reference invisible light image set, allowing to identify the pixels that are occupied by the foreground, and thus to generate a foreground mask. According to an embodiment of the invention the main computer (150) is further computing gradients from foreground to background pixels, in order to interpolate color and alpha values. According to some embodiments of the present invention the active background (110) is electronically controlled by the hardware synchronizer (130) and it can trigger invisible light flashes only when required by the system. This way, the system can reduce artifacts by comparing natural ambient invisible light amount to invisible light emitted by the active background (110). The system finally generates a live stream of images containing an alpha channel insuring great looking spatial transition with the foreground.

In one embodiment of the invention, a system setup (312) is initially performed. The components can be placed in such configurations as allowing the subject to be located between the camera (120) and the active background (110). One example for such a system configuration is schematically illustrated in FIG. 1. The active background (110) can be either one or several surfaces emitting or reflecting IL towards one or several cameras (120). For example in one configuration the IL emitter can be facing the background surface and in that case, the IL is emitted towards the surface and rebounds on the opaque and reflective background surface. In another configuration the IL emitter can be behind the background surface and facing the camera. In such a setup, the IL travels through the background surface towards the camera (120). This time, the background surface is not opaque and reflective, but translucent to IL. Further configurations can be related also to the background surface that may be either painted or printed, respecting the needs of the chosen setup (IL reflectivity or translucency, if related to the above configuration examples). One of the possibilities to achieve translucency can be by using micro-perforated printed material. Another configurations are related to the technologies used for the IL emitter, which includes projectors or LED strips in any spectrum that is below or above what the human eye can perceive (such as, but not limited to, infra-red or ultra violet spectrums). As an example, in a setup where the lighting system is based on LED technology, a LED driver (140) could be used in order to provide the highest supported electric current to the lightning system with less than 10us ramp up and down. Further system setup (312) aspects to be configured can include those related to the usage of a hardware synchronizer (130). Depending on different conditions like the ambient invisible light, available functionalities on the camera (120) and a balance between latency and resilience then different configurations can be considered. For example when the ambient IL is very low (generally indoors with controlled lighting system) the hardware synchronizer (130) can be removed and leave the IL emitter always switched on. In such a setup a camera that wouldn't feature a synchronization signal can be used. Other examples include setups where the hardware synchronizer (130) is used in Flash mode, in Strobe mode or in Double Strobe mode.

In one embodiment of the invention, subsequently to the system setup (312) the system can be triggered to start a new recording (314). In a preferred embodiment the whole system can start up by itself once plugged, the main computer (150) auto boot a client application dedicated for the real time processing and the hardware synchronizer (130) always emits its trigger signals. The client application will further send the startup sequence and change the hardware synchronizer (130) mode if needed.

In one embodiment of the invention, the real time processing is preceded by a calibration step when background reference images (316) are acquired and stored in the main computer (150). This step requires that no foreground object is present. The reference images are acquired both with and without illumination in the VL and IL spectrums. The main computer (150) is creating 3 reference maps, storing for each pixel mean value and standard deviation as follows: the first reference map for the 3 color channels of the visible spectrum (RGB), the second with the IL spectrum values with backlighting on and the third in the IL spectrum with backlighting off. According to some embodiments of the present invention such a recalibration (330) can be executed during the video recording, reference images being automatically recomputed when no foreground object is detected for a given period of time. For example, the recalibration is mostly needed when the lightning conditions are changing drastically. Other situations that could require recalibration includes scenarios when the background have been moved a little bit (happening for example when the subject collide with the background while playing).

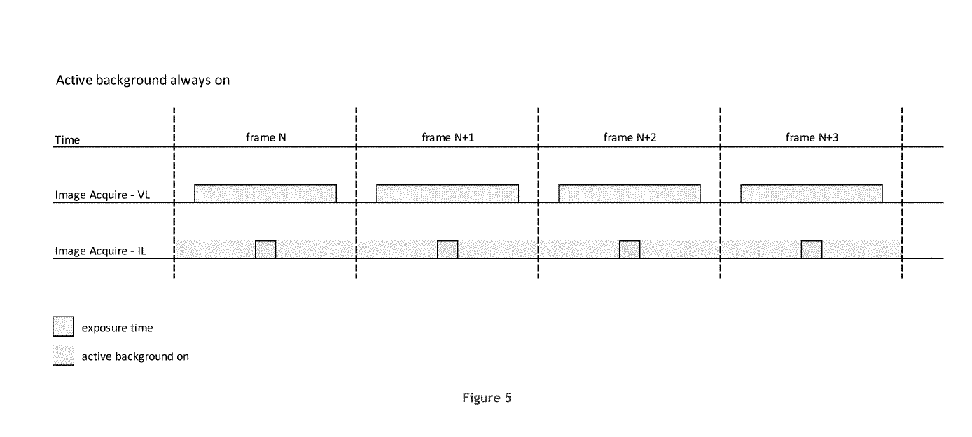

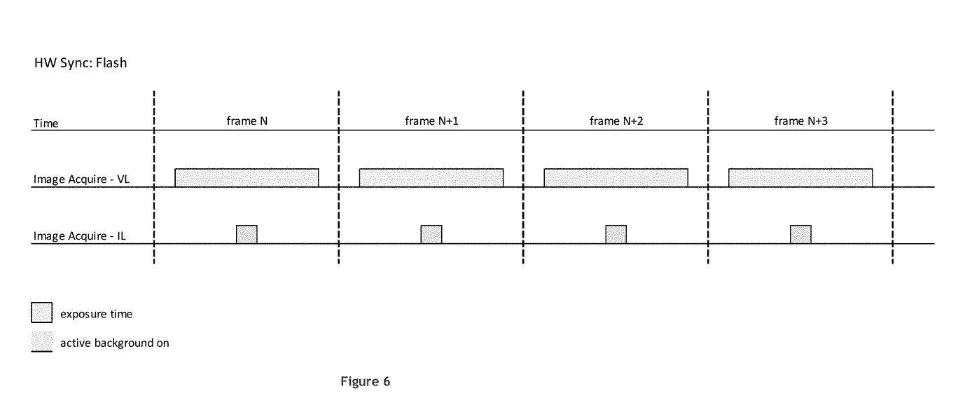

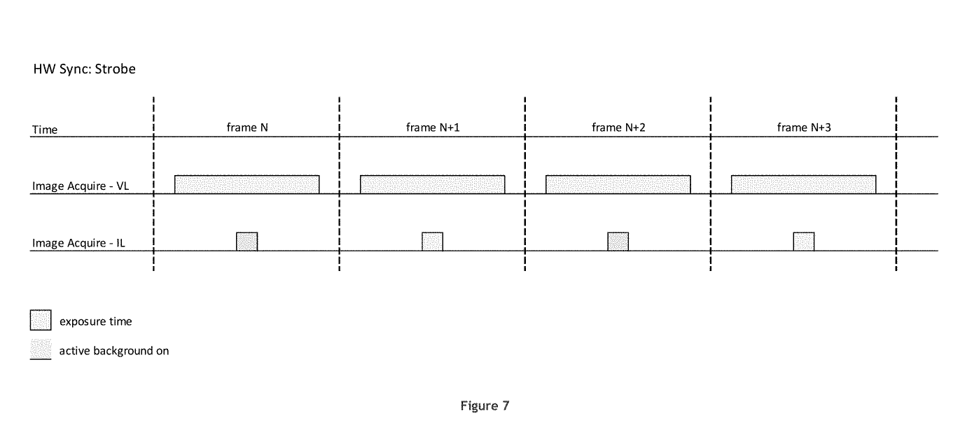

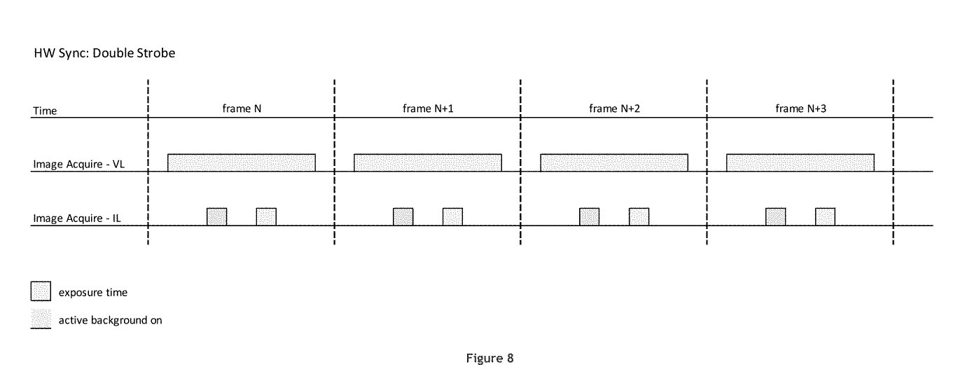

In a preferred embodiment, the real time processing is performed frame by frame (320) by the main computer (150) based on the frame images (318) acquired by the camera (120) in both visible and invisible spectrums. During the IL frame images acquisition (318) the background lightning is ensured either by keeping the IL emitter always switched on or by using the hardware synchronizer (130) to set the timing for the invisible lightning system and the camera exposure, wherein the IL exposure time is kept very short compared to the visible light exposure time. Considering the usage of the hardware synchronizer (130) different scenarios will be further described. FIG. 5 schematically illustrates an example for the VL Et IL image acquisition process in a scenario wherein the hardware synchronizer (130) is not used. In such a scenario the IL emitter is always switched on and the IL image is taken in the middle of the exposure time of the visible image. Another scenario is schematically illustrated in FIG. 6 wherein the hardware synchronizer (130) is used in Flash mode. In such a case the active background will provide a short burst of IL, matching the short exposure window on the IL camera's sensor and the IL image is taken in the middle of the exposure time of the visible image. One of the advantages of using the Flash mode are obvious when using the LED technology as IL emitter, when the system could overload the LEDs during a short period of time (flash) to produce more invisible light. Another two scenarios (Strobe and Double Strobe) will be further described for a preferred embodiment wherein the noise reduction (321) step is part of the real time processing. FIG. 7 schematically illustrates an example for the VL & IL image acquisition process in a scenario wherein the hardware synchronizer (130) is used in Strobe mode, meaning the IL lightning—is alternatively switched on and off. For example, considering two consecutive frames (“N” and “N+1”), if for the first frame (“N”) the IL image will be acquired with the active background on then for the second frame (“N+1”) the IL image will be acquired having the active background off. The other scenario is schematically illustrated in FIG. 8 wherein the hardware synchronizer (130) is used in Double Strobe mode. In such a case the camera (120) acquires two IL images for each RGB frame, one with the background IL on and the other with IL lightning off. The two IL images are taken as close as possible in time (in order to achieve best motion artefact reduction) while close to the middle of the exposure time of the visible image.

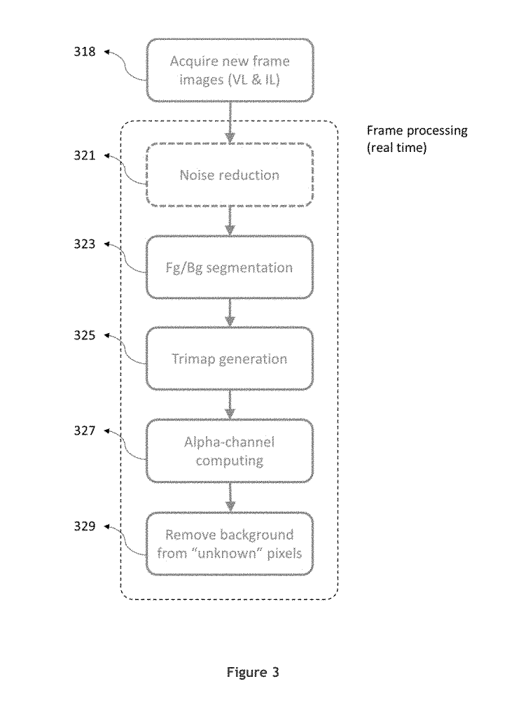

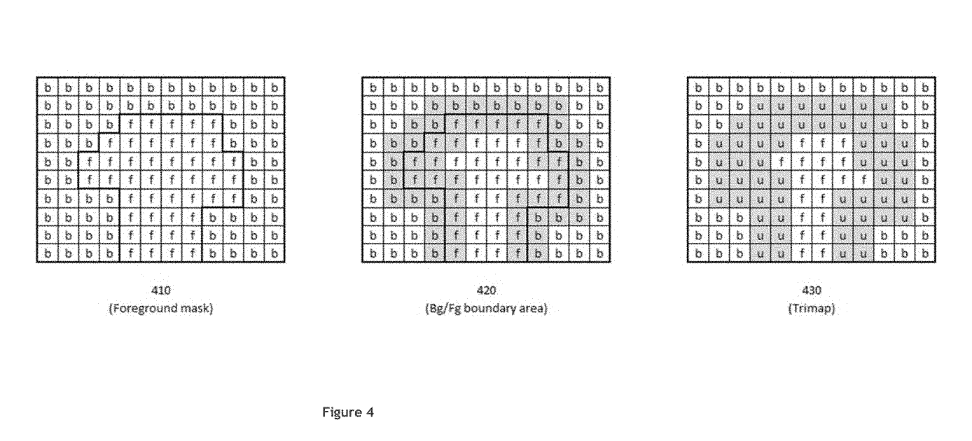

A step by step method for performing a real time frame processing (320) is schematically illustrated in FIG. 3. In a preferred embodiment, it is assumed that the hardware synchronizer (130) was used in Strobe or Double Strobe modes so that the first step to be performed in frame processing is noise reduction (321) which will be described in detail later in the document. Otherwise, if the hardware synchronizer (130) was used in Flash mode or not used at all (IL emitter was always switched on), then the noise reduction (321) step is skipped. Further in the process the foreground/background segmentation (323) is performed by comparing current frame IL pixel values with the reference values from the second recorded map (IL spectrum values with backlighting on) and generating a foreground mask (410). In one embodiment of the invention, if the difference between the value of each pixel and the reference mean exceeds three times the standard deviation, then the pixel is segmented as foreground and otherwise as background. In another embodiment, when in Strobe mode, the absolute difference between the current IL frame and the previous IL frame is threshold to obtain a foreground/background segmentation. While in Double Strobe mode, the last IL frame with a IL state different from the current one is subtracted from the current IL frame. The absolute value of the result is threshold to obtain a foreground/background segmentation. Based on the foreground/background segmentation (323), the further step of the real time processing is the trimap generation (325). Any pixel within a given distance from a foreground/background boundary (420) is marked as “unknown”. Implementation can be done for example using morphological operators (dilation and erosion). FIG. 4 schematically illustrates an example of the Trimap generation process wherein background pixels are marked with “b” and foreground pixels with “f”, while the computed “unknown” pixels with “u”. In a preferred embodiment the input image and the trimap (430) can be further used to compute a full alpha channel (327) and to remove the influence of the background (329) from “unknown” pixels by the means of using the visibility ratio “alpha”.

In one embodiment of the invention, in order to compute the alpha-channel (327) the system estimates the ratio of foreground visibility (“alpha”) as follows: “alpha”=(il−bg_il)/(fg_il−bg_il) where bg_il is an estimate of the IL intensity that would be measured if the pixel was showing only the background, and where fg_il is an estimate of the IL intensity that would be measured if the pixel was totally showing the foreground object. One possibility to estimate bg_il is to use the proper reference map taken when no foreground is present (with either backlighting on or off). Another option is to search the closest pixel marked as background in the trimap and to the current frame IL pixel at this location as an estimate for bg_il. One possibility to estimate fg_il is by searching the closest pixel on the trimap marked as foreground, and to use the IL value for the pixel at this location as fg_il. When searching for the nearest pixel different methodologies can be further applied. One possibility could be to accelerate the computation of searching the nearest pixel satisfying some properties by using a Distance Transform algorithm, modified to keep track of which pixel is the closest [Felzenszwalb 2004].

In one embodiment of the invention, the visibility ratio “alpha” can be used to remove the influence of the background on “unknown” pixels. In one of the embodiments the color “fg” without background influence can be computed in the following way: “fg”=measured/alpha−estimatedBg*(1/alpha−1) where “measured” is the measured RGB pixel from the input image, and where estimatedBg is an estimate of the RGB color of the background at this location. One possible method to estimate the background color for a pixel within the unknown zone of the trimap is to look at the nearest pixel marked as background in the trimap and use this color, or use an average of neighboring colors. Another option is to rely on a color background model. In a preferred embodiment a reference color model showing the background is acquired. It would not be used directly since illumination and camera acquisition settings might have change between background acquisition time and the current frame. It is necessary to estimate illumination locally to correct the color background model. Doing so consists in multiplying the background model pixel at the estimated location by the ratio between a current frame pixel at a close known background location with the background model pixel at the same location.

According to some embodiments of the present invention the hardware synchronizer (130) is used either in Strobe or Double Strobe modes so that noise reduction (321) can be performed as the first step in frame processing. This can be achieved by comparing two consecutive IL images (one with the background IL on and the other with the background IL off), then subtracting the two consecutive IL images together and storing the absolute value for each pixel. This value will have the ambient IL influence removed and can be further used in the real time processing. For example, when in Double Strobe mode one possibility to achieve this is by acquiring the two IL frames with a very short aperture time (for example close to 200 us) and a negligible delay between them (for example less than 1 ms). Additionally, when in Strobe mode, the last 2 frames are stored. By comparing the current frame with the one taken with the same lighting conditions, movement compensation can be further achieved. In one embodiment of the invention camera movement can be also achieved by using for example external augmented reality engines to compute camera position and movement to find the proper pixel to pixel matching to the reference background model.

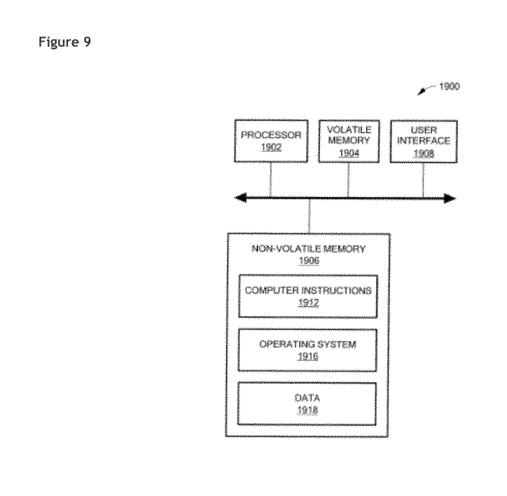

Referring to FIG. 9, in one example, a computer 1900 includes a processor 1902, a volatile memory 1904, a non-volatile memory 1906 (e.g., hard disk) and the user interface (UI) 1908 (e.g., a graphical user interface, a mouse, a keyboard, a display, touch screen and so forth). The non-volatile memory 1906 stores computer instructions 1912, an operating system 1916 and data 1918. In one example, the computer instructions 1912 are executed by the processor 1902 out of volatile memory 1904 to perform all or part of the processes described herein.

The processes described herein are not limited to use with the hardware and software of FIG. 19; they may find applicability in any computing or processing environment and with any type of machine or set of machines that is capable of running a computer program. The processes described herein may be implemented in hardware, software, or a combination of the two. The processes described herein may be implemented in computer programs executed on programmable computers/machines that each includes a processor, a non-transitory machine-readable medium or other article of manufacture that is readable by the processor (including volatile and non-volatile memory and/or storage elements), at least one input device, and one or more output devices. Program code may be applied to data entered using an input device to perform any of the processes described herein and to generate output information.

The system may be implemented, at least in part, via a computer program product, (e.g., in a non-transitory machine-readable storage medium such as, for example, a non-transitory computer-readable medium), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a non-transitory machine-readable medium that is readable by a general or special purpose programmable computer for configuring and operating the computer when the non-transitory machine-readable medium is read by the computer to perform the processes described herein. For example, the processes described herein may also be implemented as a non-transitory machine-readable storage medium, configured with a computer program, where upon execution, instructions in the computer program cause the computer to operate in accordance with the processes. A non-transitory machine-readable medium may include but is not limited to a hard drive, compact disc, flash memory, non-volatile memory, volatile memory, magnetic diskette and so forth but does not include a transitory signal per se.

The processing blocks (for example, in the processes described herein associated with implementing the system may be performed by one or more programmable processors executing one or more computer programs to perform the functions of the system. All or part of the system may be implemented as, special purpose logic circuitry (e.g., an FPGA (field-programmable gate array) and/or an ASIC (application-specific integrated circuit)). All or part of the system may be implemented using electronic hardware circuitry that include electronic devices such as, for example, at least one of a processor, a memory, a programmable logic device or a logic gate.

Elements of different embodiments described herein may be combined to form other embodiments not specifically set forth above. Various elements, which are described in the context of a single embodiment, may also be provided separately or in any suitable sub combination. Other embodiments not specifically described herein are also within the scope of the following claims.

### CITATIONS

2007, Davis, James W and Sharma, Vinay
   Background-subtraction using contour-based fusion of thermal and visible imagery [Journal: “Computer Vision and Image Understanding”]
2014, Cerny, J.
   System for capturing scene and nir relighting effects in movie postproduction transmission [Patent, publication number: WO2014057335]
2011, Relyea, D. and Felt, M.
   Image compositing via multi-spectral detection
   [Patent, publication number: US20110117532]
2004, Pedro F. Felzenszwalb and Daniel P. Huttenlocher
   Distance Transforms of Sampled Functions

1. A method, comprising:
controlling emission of invisible light from an active background;
employing a multispectral camera to record an image from invisible light (IL) received from the active background and to record an image from visible light (VL); and
processing the image from the invisible light to determine pixels associated with a foreground located between the active background and the camera.

2. The method according to claim 1, wherein the invisible light is generated from behind the active background which is at least partially translucent.

3. The method according to claim 1, wherein the invisible light is reflected by the active background.

4. The method according to claim 1, further including triggering flashes of the invisible light from the active background.

5. The method according to claim 1, further including controlling the emission of the invisible light based upon a level of visible ambient light.

6. The method according to claim 1, wherein the VL image comprises RGB pixel values and the IL image comprises pixel intensity value for the IL spectrum.

7. The method according to claim 1, further including processing the image using pixel maps including a first reference map of RGB values for each pixel, a second reference map of IL spectrum values without IL emission, and a third reference map of IL spectrum values with IL emission.

8. The method according to claim 7, further including generating a foreground mask by comparing the IL spectrum values for a current frame with the second reference map of IL spectrum values without IL emission.

9. The method according to claim 1, further including generating a foreground mask by comparing IL spectrum values for a current frame with IL spectrum values for a previous frame.

10. The method according to claim 1, further including performing recalibration when lighting conditions have changed by more than a selected threshold.

11. The method according to claim 1, further including synchronizing emission of the IL and image acquisition for the VL image.

12. The method according to claim 11, further including synchronizing a pulse of IL emission and image acquisition for the IL image.

13. The method according to claim 1, further including assigning each pixel as background, foreground or unknown, and processing the unknown pixels to determine an alpha channel corresponding to the VL image.

14. The method according to claim 13, further including determining the alpha channel using a foreground visibility ratio.

15. A system comprising:
a backlighting system to selectably provide invisible light emission;
a multispectral camera to acquire an invisible light image from the invisible light emitted by the backlighting system and to acquire a visible light image;
a signal generator to control the invisible light emission by the backlighting system; and
a processing module to process the image from the invisible light to determine pixels associated with a foreground located between the backlighting system and the camera.

16. A system according to claim 15, wherein the backlighting system consists of one or several surfaces emitting or reflecting light in the invisible spectrum

17. A system according to one of claims 15-16, wherein the backlighting system is able to produce short flashes of invisible light by the means of:
a programmable hardware trigger signals generator
an invisible light driver to power up and control the IL emitter

18. A system of claim 17, wherein the system is able to filter out the invisible light which does not come from the backlighting system

19. A system according to one of the preceding claims, wherein the backlighting system is illuminating in one of the Infra-Red, Near Infra-Red (NIR) or ultra violet spectrums.

20. A system of claim 19, wherein LED strips are used as the IL emitter and a LED driver is used to reach maximal burst electric current during flash.
